(19) United States
(12) Patent Application Publication
(10) Pub. No.: US 2026/0125616 A1
(43) Pub. Date: May 7, 2026

(54) Carpet Cleaning Chemical Composition and Method of Application

(71) Applicants: Nathaniel Lemieux, Colorado Springs, CO (US); Bruce Robert Davis, Colorado Springs, CO (US); Brandon Lee McKim, Colorado Springs, CO (US)

(72) Inventors: Nathaniel Lemieux, Colorado Springs, CO (US); Bruce Robert Davis, Colorado Springs, CO (US); Brandon Lee McKim, Colorado Springs, CO (US)

(21) Appl. No.: 18/938,084

(22) Filed: Nov. 5, 2024

(51) Int. Cl. C11D 3/00; C11D 3/20; C11D 3/37; C11D 3/382

(52) U.S. Cl. CPC C11D 3/0031; C11D 3/0068; C11D 3/2003; C11D 3/3703; C11D 3/382

(57) ABSTRACT

The carpet cleaning chemical composition is a chemical formulation of a neutralizer and a fabric protectant within one mix that is applied to a carpet surface and fiber to properly neutralize carpet cleaners, improving the longevity and cleanliness of the carpet or upholstery. The carpet cleaning chemical composition is applied to the carpet or upholstery surface via the chemical feed to the water lines of a truck mounted cleaning system or portable cleaning system, wherein an all fiber rinse combination is mixed with a Teflon based chemical agent as the fabric protectant.

### FIELD OF THE INVENTION

The present invention relates generally to carpet cleaning composition and method of use. More specifically, the present invention is a fabric protectant 1 and a neutralizer 2 that efficiently and safely cleans a carpet in residential or industrial settings.

### BACKGROUND OF THE INVENTION

The carpet cleaning process includes chemical selection, agitation, time, heat and neutralizing. Once all of these process steps are completed, most commercial carpet/upholstery service providers will ask the customer if they wish to purchase a carpet/upholstery protectant application. However, many purchasers of carpet cleaning services often forego the purchase of protectant chemical application, due to the added time and cost involved with such services. By combining the application of rinsing chemicals along with the application of protectant chemicals as a single process step, the present invention overcomes the time-domain factor of the cost equation. The selection of cleaning agents for carpet/upholstery cleaning are largely dependent upon the type of carpet material (synthetic versus natural) and the type of carpet/upholstery stain. As a general rule, most synthetic carpets/upholstery require an alkaline cleaning agent, while most natural carpet/upholstery fabrics require an acidic cleaning agent. After the selected cleaning agent is applied to carpet/upholstery, then an appropriate rinsing agent is required to bring the pH of the cleaning chemical infusion back to the neutral (pH of 7) range. In this context, there would be both acidic and basic versions of the present invention having the combined rinsing and protectant formulation. The selected cleaning agent and the selected rinse and protectant agent formulation would typically be applied with either a truck mounted cleaning system 5 or a portable cleaning system 6 which is AC powered. The present invention combines rinsing agent and protectant agent into one formulation as well as provides steps on how the chemical agents are used with either a truck mounted cleaning system 5 or a portable cleaning system 6.

Millions and millions of people own a home carpet cleaner. Many of these people are using them wrong. Most of the directions say to pour the shampoo into the water and clean. This method of cleaning the carpets leaves harmful shampoo on the carpet. This starts to attract more dirt while additionally being bad for pets and children. The present invention provides individuals with the rinse and carpet protector that they are lacking. This ensures a safer clean while holding up the carpet warranty.

### BRIEF DESCRIPTION OF THE DRAWINGS

FIG. 1 is a block diagram of the carpet cleaning chemical solution.

FIG. 2 is a block diagram of the cleaning system.

FIG. 3 is a flow diagram of the carpet cleaning chemical solution method of application.

FIG. 4 is an illustration of a user utilizing a cleaning system.

### DETAILED DESCRIPTION OF THE INVENTION

All illustrations of the drawings are for the purpose of describing selected versions of the present invention and are not intended to limit the scope of the present invention.

The present invention is a chemical formulation of a neutralizer 2 and a fabric protectant 1 that is all in one mix. In the chemical feed 41 to the water lines 43 of a truck mounted cleaning system 5, an all fiber rinse combination is mixed with a Teflon based chemical agent as the protectant. For example the present invention could utilize “Chemspec All Fiber Textile Rinse” for the all fiber rinse and “Groom Solutions CP509GL Relax Carpet & Upholstery Protector” as the Teflon-based fabric protectant 1 agent.

The present invention is a fabric protectant 1 as a rinsing agent with the neutralizer 2 which acts as a secondary safe cleaning agent. fabric protectants 1 are tacky and instead of emulsifying, they grab the soils. This ensures a second cleaning that pulls not only shampoos and spotters out, but hard to reach soils the emulsifying is not taking off. Further, the present invention allows for individuals to neutralize, carpet protect and deodorize with a molecule modifying safe deodorizer 3 added to this product. Various combinations of specific deodorizers 3 can be utilized for different situations. The present invention is designed to neutralize the carpet which enables the fabric protectants 1 and even deodorizers 3 to bond to the carpet better and easier. In situations where the carpet is not properly neutralized the shampoos can damage and eliminate the fabric protectants 1 resulting in the fabric protectants 1 breaking off with the shampoo residues. Furthermore, neutralizing shampoos and spotters also keeps carpets cleaner for longer periods of time. This results in no residues attracting back to the carpets. In some cases, a neutralizer 2 also repels soils just as much as a fabric protectant 1. Further, the present invention is environmentally safe by neutralizing the high pH the shampoos and spotters. By neutralizing the shampoos, this makes it environmentally safe for regular residential disposal. Furthermore, the fabric protectant 1 is being applied into the base of the carpet fibers which acts as a secondary cleaning process and protects the fibers simultaneously.

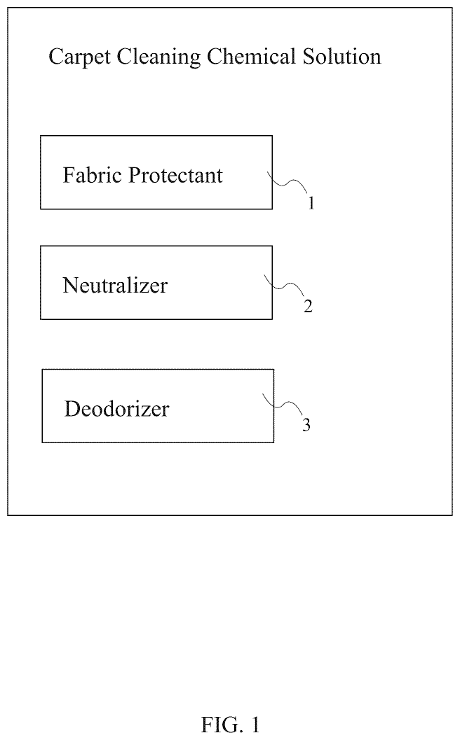

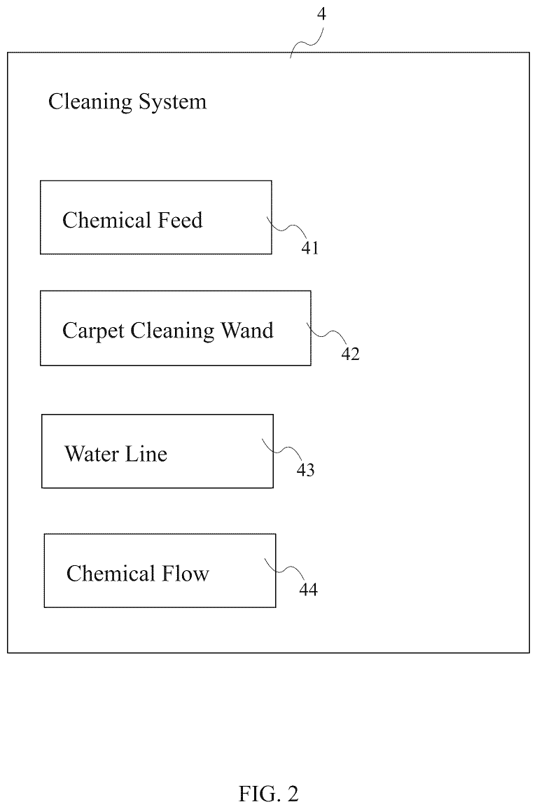

The present invention is a method for applying a carpet cleaning chemical composition as seen in FIG. 1-4. The method for applying a carpet cleaning chemical composition comprises a cleaning system 4 wherein the cleaning system 4 further comprises a carpet cleaning wand 42, a water line 43, a chemical feed 41 and a chemical flow 44. The chemical feed 41 is a comprised of a carpet cleaning chemical composition wherein the amount of water dilution is adjusted by the chemical flow 44. The chemical feed 41 injects the carpet cleaning chemical composition in to the water line 43 wherein the carpet cleaning chemical composition then flows into the carpet cleaning wand 42 wherein it is sprayed out onto the carpet surface. The method begins with mixing a fabric protectant 1 and a neutralizer 2 into a chemical feed 41. Next the method mixes water into the chemical feed 41. Then the method adjusts the dilution of the chemical feed 41. The chemical feed 41 dilution controlled with positive displacement metering pumps to ensure the proper dosage is formed and met. Finally, the method applies the chemical feed 41 to a carpet surface with a cleaning system 4. Further, in an alternative embodiment the method mixes a deodorizer 3 into the chemical feed 41.

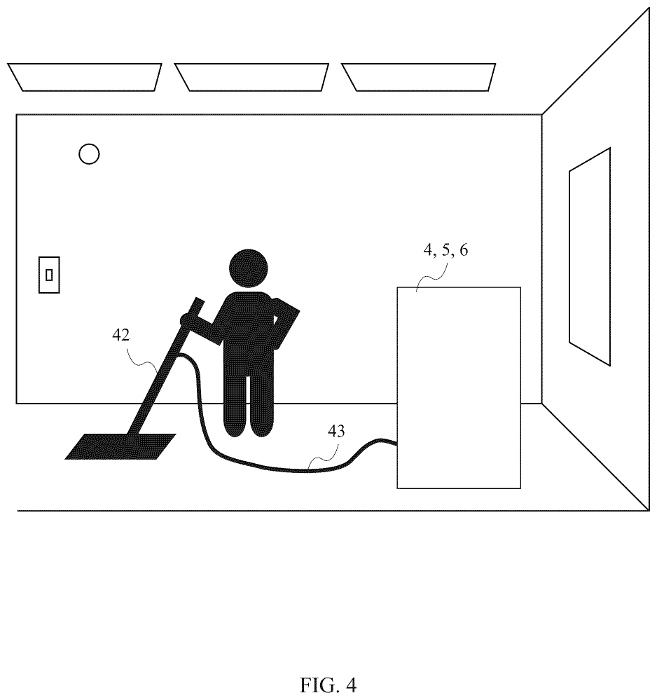

Furthermore, the method utilizes a truck mount cleaning system 5 to apply the chemical feed 41 to the carpet surface. A portable cleaning system 6 is then utilized to apply the chemical feed 41 to the carpet surface. Either system allows for the chemical feed 41 to be sprayed onto the carpet surface after a carpet cleaner or upholstery cleaner is utilized and leaves behind a residue in the pH range of 8-14. Additionally, as shown in FIG. 4, the method utilizes a carpet cleaning wand 42 to spray the chemical feed 41.

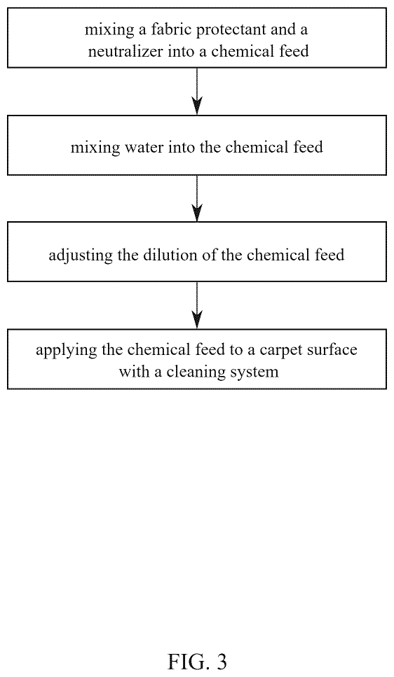

As shown in FIG. 3, the chemical feed 41 neutralizes a carpet cleaning product on the carpet surface. This enables the residue of the carpet cleaning product to be properly disposed without harmfully effecting the environment. Furthermore, the method of the present invention identifies a problem from the carpet. Then adds or subtracts a chemical from the chemical feed 41 based on the problem.

In reference to FIG. 1, the present invention is a carpet cleaning chemical composition comprising a fabric protectant 1, a neutralizer 2 and water. The neutralizer 2 may be an all fiber textile rinse, where in the neutralizer 2 is a mild acidic solution that removes cleaning residues and soiling. The neutralizer 2 results in a clean and soft carpet texture feel. Furthermore, the neutralizer 2 prevents browning and stabilizes colors and dyes to prevent bleeding. The fabric protectant 1 utilizes fluorochemical technology for enhanced water and oil based soil resistance. The fabric protectant 1 provides a dispersal of solution across the entire area of the carpet being treated to ensure equal treatment of all sprayed areas. The carpet protect reduces carpet wear from abrasive soling, especially in high traffic areas. This results in subsequent vacuuming to be easier, faster, and more efficient. The fabric protectant 1 further utilizes C6 polymer technology that results in a carpet being cleaner, brighter, and fresher after use of the fabric protectant 1. Furthermore, this ensures a non-toxic solution that is safe for children and pets. In an alternative embodiment the present invention comprises a deodorizer 3. The deodorizer 3 protects against smoke damage, provides a fresh smell to the carpet surface, and removes unwanted odors from pets, such as urine and other soiling. Furthermore, the deodorizer 3 does not break down wool fibers, is nonflammable, noncorrosive, nontoxic, nonstaining and is biodegradable. The deodorizer 3 can be added to the cleaning chemical composition at various amounts depending on the specific carpet problem needing to be solved.

Further, the fabric protect is designed with a pH between 4.5 and 5.5. Furthermore, the neutralizer 2 is designed with a pH between 1.5 and 2.5. Thus, the neutralizer 2 properly brings the shampoo or carpet cleaner product pH level back to a neutral pH of 7 level.

In reference to FIG. 1, the deodorizer 3 further comprises deionized water and natural plant oils. Furthermore, the deodorizer 3 further comprises condensation products and monohydric compounds. The deodorizer 3 further comprises hydroxy containing organic compounds and oxidized hydroxyl containing organic compounds.

Although the invention has been explained in relation to its preferred embodiment, it is to be understood that many other possible modifications and variations can be made without departing from the spirit and scope of the invention as hereinafter claimed.

What is claimed is:

1. A method for applying a carpet cleaning chemical composition comprising:
a cleaning system;
the cleaning system further comprising a carpet cleaning wand, a water line, a chemical feed and a chemical flow;
mixing a fabric protectant and a neutralizer into a chemical feed;
mixing water into the chemical feed;
adjusting the dilution of the chemical feed; and
applying the chemical feed to a carpet surface with a cleaning system.

2. The method for applying a carpet cleaning chemical composition as claimed in claim 1 comprising mixing a deodorizer into the chemical feed.

3. The method for applying a carpet cleaning chemical composition as claimed in claim 2 comprising:
utilizing a truck mount cleaning system to apply the chemical feed to the carpet surface; and
utilizing a portable cleaning system to apply the chemical feed to the carpet surface.

4. The method for applying a carpet cleaning chemical composition as claimed in claim 2 comprising utilizing a carpet wand to spray the chemical feed.

5. The method for applying a carpet cleaning chemical composition as claimed in claim 2 wherein the chemical feed is neutralizing a carpet cleaning product on the carpet surface.

6. The method for applying a carpet cleaning chemical composition as claimed in claim 1 comprising:
identifying a problem from the carpet; and
adding or subtracting a chemical from the chemical feed based on the problem.

7. A carpet cleaning chemical composition comprising:
a fabric protectant;
a neutralizer; and
water.

8. The carpet cleaning chemical composition as claimed in claim 7 further comprising a deodorizer.

9. The carpet chemical composition as claimed in claim 8 wherein the fabric protectant has a pH between 4.5 and 5.5.

10. The carpet cleaning chemical composition as claimed in claim 8 wherein the neutralizer has a pH between 1.5 and 2.5.

11. The carpet cleaning chemical composition as claimed in claim 8 wherein the deodorizer further comprises deionized water and natural plant oils.

12. The carpet cleaning chemical composition as claimed in claim 11 wherein the deodorizer further comprises condensation products and monohydric compounds.

13. The carpet cleaning chemical composition as claimed in claim 11 wherein the deodorizer further comprises hydroxy containing organic compounds and oxidized hydroxyl containing organic compounds.

14. A carpet cleaning chemical composition comprising:
a fabric protectant;
a neutralizer;
water; and
a deodorizer.

15. The carpet chemical composition as claimed in claim 14 comprising:
the fabric protectant with a pH between 4.5 and 5.5; and
the neutralizer with a pH between 1.5 and 2.5.

16. The carpet cleaning chemical composition as claimed in claim 14 wherein the deodorizer further comprises deionized water and natural plant oils.

17. The carpet cleaning chemical composition as claimed in claim 16 wherein the deodorizer further comprises condensation products and monohydric compounds.

18. The carpet cleaning chemical composition as claimed in claim 16 wherein the deodorizer further comprises hydroxy containing organic compounds and oxidized hydroxyl containing organic compounds.
